(19) United States
(12) Patent Application Publication
(10) Pub. No.: US 2020/0218794 A1
(43) Pub. Date: Jul. 9, 2020

(54) IDENTITY AUTHENTICATION, UNLOCKING, AND PAYMENT METHODS AND APPARATUSES, STORAGE MEDIA, PRODUCTS, AND DEVICES

(71) Applicant: BEIJING SENSETIME TECHNOLOGY DEVELOPMENT CO., LTD., Beijing (CN)

(72) Inventors: Dixin ZHENG, Beijing (CN); Ding LIANG, Beijing (CN)

(21) Appl. No.: 16/828,251

(22) Filed: Mar. 24, 2020

Related U.S. Application Data
(63) Continuation of application No. PCT/CN2018/123259, filed on Dec. 24, 2018.

(30) Foreign Application Priority Data
Apr. 4, 2018 (CN) 201810301607.1

(51) Int. Cl. G06F 21/36; G06Q 20/40; G06K 9/00; G06K 9/38

(52) U.S. Cl. CPC G06F 21/36; G06Q 20/40145; G06K 9/00268; G06K 9/38; G06K 9/00288

(57) ABSTRACT

An identity authentication method includes: obtaining first feature data of a first user image; performing quantization processing on the first feature data to obtain second feature data; and obtaining an identity authentication result based on the second feature data.

### CROSS-REFERENCE TO RELATED APPLICATIONS

The present application is a continuation of International Application No. PCT/CN2018/123259, filed on Dec. 24, 2018, which claims priority to Chinese Patent Application No. 201810301607.1, filed on Apr. 04, 2018. The disclosures of International Application No. PCT/CN2018/123259 and Chinese Patent Application No. 201810301607.1 are hereby incorporated by reference in their entireties.

### BACKGROUND

As public safety issues receive more and more attention from society, the research on face recognition technologies have been highly valued by academics, business circles and the government. In face recognition technologies, depth learning method is generally used to extract face features from face images.

However, in order to ensure the security of private information of users, the face features need to be encrypted and decrypted during information transmission in electronic devices, thereby consuming a large amount of time and resources and affecting the user experience.

### SUMMARY

Embodiments of the present disclosure relate to the field of data processing, and in particular, to identity authentication methods, unlocking methods, payment methods, as well as apparatuses thereof, storage media, program products, and electronic devices.

Embodiments of the present disclosure aim at providing technical solutions of identity authentication, technical solutions of terminal device unlocking, and technical solutions of payment.

According to a first aspect of the embodiments of the present disclosure, an identity authentication method is provided. The method includes: obtaining first feature data of a first user image; performing quantization processing on the first feature data to obtain second feature data; and obtaining an identity authentication result based on the second feature data.

According to a second aspect of the embodiments of the present disclosure, an unlocking method is provided. The method includes: obtaining a face image; processing the face image to obtain integer face feature data; and determining, based on the integer face feature data, whether to unlock a terminal device.

According to a third aspect of the embodiments of the present disclosure, a payment method is provided. The method includes: obtaining a face image; processing the face image to obtain integer face feature data; and determining, based on the integer face feature data, whether to allow payment, or sending a payment request including the integer face feature data to a server.

According to a fourth aspect of the embodiments of the present disclosure, an identity authentication apparatus is provided. The apparatus includes: a first determination module, configured to obtain first feature data of a first user image; a quantization module, configured to quantize the first feature data to obtain second feature data; and an identify authentication module, configured to obtain an identity authentication result based on the second feature data.

According to a fifth aspect of the embodiments of the present disclosure, an unlocking apparatus is provided. The apparatus includes: a second obtaining module, configured to obtain a face image; a first processing module, configured to process the face image to obtain integer face feature data; and a second release module, configured to determine, based on the integer face feature data, whether to unlock a terminal device.

According to a sixth aspect of the embodiments of the present disclosure, a payment apparatus is provided. The apparatus includes: a third obtaining module, configured to obtain a face image; a second processing module, configured to process the face image to obtain integer face feature data; and a second payment module, configured to determine, based on the integer face feature data, whether to allow payment, or send a payment request including the integer face feature data to a server.

According to a seventh aspect of the embodiments of the present disclosure, another unlocking apparatus is provided. The apparatus includes: a camera configured to collect a face image; and a processor configured to process the face image to obtain integer face feature data, and determine, based on the integer face feature data, whether to unlock a terminal device.

In some embodiments, the unlocking apparatus is configured to implement the unlocking method according to the second aspect or any optional embodiments of the second aspect. Accordingly, the unlocking apparatus includes modules or devices for implementing the operations in the method according to the second aspect or any optional embodiments of the second aspect.

According to an eighth aspect of the embodiments of the present disclosure, a payment apparatus is provided. The apparatus includes: a camera configured to collect a face image; and a processor configured to process the face image to obtain integer face feature data, and determine, based on the integer face feature data, whether to allow payment.

According to a ninth aspect of the embodiments of the present disclosure, a payment apparatus is provided. The apparatus includes: a camera configured to collect a face image; a processor configured to process the face image to obtain integer face feature data; and a transceiver configured to send a payment request including the integer face feature data to a server.

According to a tenth aspect of the embodiments of the present disclosure, a computer readable storage medium is provided, with computer program instructions stored thereon, where when executed by a processor, the program instructions implement the operations of the identity authentication method according to the first aspect or any optional embodiments of the first aspect, or implement the operations of the unlocking method according to the second aspect or any optional embodiments of the second aspect, or implement the operations of the payment method according to the third aspect or any optional embodiments of the third aspect.

According to an eleventh aspect of the embodiments of the present disclosure, a computer program product is provided, including computer program instructions, where when executed by a processor, the program instructions implement the operations of the identity authentication method according to the first aspect or any optional embodiments of the first aspect, or implement the operations of the unlocking method according to the second aspect or any optional embodiments of the second aspect, or implement the operations of the payment method according to the third aspect or any optional embodiments of the third aspect.

According to a twelfth aspect of the embodiments of the present disclosure, an electronic device is provided, including: a first processor and a first memory, where the first memory is configured to store at least one executable instruction, and the executable instruction causes the first processor to execute the operations of the identity authentication method according to the first aspect or any optional embodiments of the first aspect.

According to a thirteenth aspect of the embodiments of the present disclosure, an electronic device is provided, including: a second processor and a second memory, where the second memory is configured to store at least one executable instruction, and the executable instruction causes the second processor to execute the operations of the unlocking method according to the second aspect or any optional embodiments of the second aspect.

According to a fourteenth aspect of the embodiments of the present disclosure, an electronic device is provided, including: a third processor and a third memory, where the third memory is configured to store at least one executable instruction, and the executable instruction causes the third processor to execute the operations of the payment method according to the third aspect or any optional embodiments of the third aspect.

### BRIEF DESCRIPTION OF DRAWINGS

FIG. 1 is a flowchart of an identity authentication method according to some embodiments of the present disclosure;

FIG. 2 is a flowchart of an identity authentication method according to other embodiments of the present disclosure;

FIG. 3 is a flowchart of an unlocking method according to some embodiments of the present disclosure;

FIG. 4 is a flowchart of a payment method according to some embodiments of the present disclosure;

FIG. 5 is a structural block diagram of an identity authentication apparatus according to some embodiments of the present disclosure;

FIG. 6 is a structural block diagram of an identity authentication apparatus according to other embodiments of the present disclosure;

FIG. 7 is a structural block diagram of an unlocking apparatus according to some embodiments of the present disclosure;

FIG. 8 is a structural block diagram of a payment apparatus according to some embodiments of the present disclosure;

FIG. 9 is a structural block diagram of an electronic device according to some embodiments of the present disclosure;

FIG. 10 is a structural block diagram of an electronic device according to some embodiments of the present disclosure; and

FIG. 11 is a structural block diagram of an electronic device according to some embodiments of the present disclosure.

### DETAILED DESCRIPTION

The specific implementations of the embodiments of the present disclosure are further described in detail below with reference to the accompanying drawings (the same reference numerals in a plurality of accompanying drawings represent the same elements) and the embodiments. The following embodiments are intended to illustrate the present disclosure, but are not intended to limit the scope of the present disclosure.

A person skilled in the art may understand that the terms such as “first” and “second” in the embodiments of the present disclosure are only used to distinguish different operations, devices or modules, etc., and do not represent any specific technical meaning or an inevitable logical sequence therebetween.

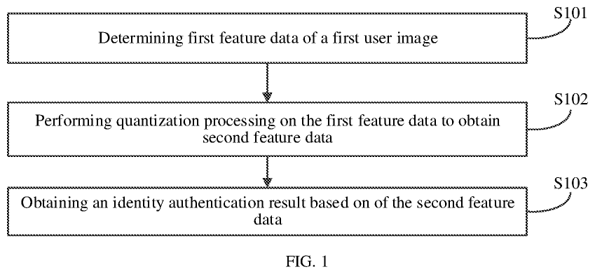

FIG. 1 is a flowchart of an identity authentication method according to some embodiments of the present disclosure.

In operation S101, first feature data of a first user image is obtained.

In the embodiments of the present disclosure, in terms of contents included in an image, the first user image includes a face image or a head image of a user, such as a front face image of the user, a front head image of the user, a front half-body image of the user, or a front whole-body image of the user; and in terms of image categories, the first user image includes a static image, a video frame image in a video sequence, a synthesized image, or the like. The embodiments of the present disclosure do not set limitations on the implementation of the first user image.

The first feature data includes face feature data, head feature data, upper-body feature data, body feature data, or the like. In some embodiments, the first feature data is a feature vector, for example, the first feature data is an original or processed feature vector (hereinafter referred to as a first feature vector) obtained from the first user image, and a data type of a value in each dimension of the first feature vector is a floating-point type. In some embodiments, the dimension of the first feature vector is 128, 256 or other values. The embodiments of the present disclosure do not define the implementation of the first feature data.

In some embodiments, the first user image is first obtained, and then feature extraction processing is performed on the obtained first user image to obtain the first feature data of the first user image. The first user image can be obtained in multiple approaches. In some embodiments, image acquiring is performed by means of a camera to obtain the first user image, where the camera optionally performs static image acquiring to obtain the first user image, or performs video acquiring to obtain the video stream and frame selection from the video stream to obtain the first user image. In other embodiments, the first user image is obtained from other devices, for example, a server receives the first user image sent by a terminal device, or receives the video stream sent by the terminal device and after receiving the video stream, performs frame selection from the video stream to obtain the first user image. In addition, the first user image is processed by means of a machine learning-based feature extraction algorithm to obtain the first feature data. For example, the first feature data of the first user image is extracted from the first user image by means of a neural network for feature extraction. It can be understood that no limitation is made in the embodiments, and any implementation of obtaining the first feature data from the first user image is applicable to the embodiment. In other embodiments, the first feature data is obtained in other approaches, for example, the first feature data is received from other devices, where in an example, the server receives the first feature data from the terminal device, which is not limited in the embodiments. The first feature data, the first user image or video stream may be carried in an identity authentication request, an unlocking request, a payment request, or other types of messages sent by the terminal device, which is not limited in the embodiments of the present disclosure.

In some embodiments, the obtaining first feature data of a first user image includes: receiving a request message carrying the first feature data of the first user image sent by the terminal device. In some embodiments, the method further includes: sending a response message indicating an identity authentication result to the terminal device.

In operation S102, quantization processing is performed on the first feature data to obtain second feature data.

In the embodiments of the present disclosure, the second feature data includes feature data of integer type. In some embodiments, the second feature data is a feature vector (hereinafter referred to as a second feature vector) obtained after quantization is performed on the first feature vector, and the data type of a value of each dimension in the second feature vector is an integer type. In some embodiments, the dimension of the second feature vector is 1024 or other values, which is not limited in the embodiments of the present disclosure.

In some embodiments, the quantization is binary quantization. In this case, quantization processing is performed on the first feature data as a binary numerical sequence consisting of 0 and/or 1, i.e., the second feature data includes the binary numerical sequence. In some embodiments, each element in the first feature vector is subjected to binary quantization by using a sign function. For example, if the value of an element in the first feature vector is greater than zero, the element is quantized as 1, and if the value of an element in the first feature vector is less than or equal to zero, the element is quantized as zero. Or the binary quantization may be performed in other approaches. In other embodiments, the quantization is performed on the first feature data in other approaches, which is not limited in the embodiments of the present disclosure.

In some embodiments, in the case that the first feature data is the first feature vector, the elements in the first feature vector is separately quantized, for example, an element in the first feature vector is quantized as 0 or 1, or an element in the first feature vector is quantized as 1, 2 or other values. In an optional implementation of the present disclosure, quantization processing is performed on each element in the first feature vector, for example, an element in the first feature vector is quantized as 0, 1, or 2, or an element in the first feature vector is quantized as 1, 2, 3, or 4, or the like, which is not limited in the embodiments of the present disclosure. In addition, the dimension of the second feature data is identical to the dimension of the first feature data, or, the dimension of the second feature data is greater than the dimension of the first feature data, which is conducive to improving the accuracy of authentication.

In operation S103, the identity authentication result is obtained based on the second feature data.

The identity authentication result includes identity authentication success or identity authentication failure.

In some embodiments, the first user image is an image collected during performing identity authentication on the user. In this case, the identity authentication result of the first user image may be obtained based on a matching result of the second feature data and preset feature data. In some embodiments, the preset feature data is quantized feature data obtained via a quantization approach same as the one for the first feature data, for example, one or more integer feature vectors are included, which is not limited in the embodiments of the present disclosure. In some embodiments, the preset feature data is a binary numerical sequence. Sine a machine instruction identified and executed by an electronic device is represented by a binary number, the use of the preset feature data that is the binary numerical sequence can improve the speed of identity authentication. For example, if the second feature data matches the preset feature data, it is obtained that the identity authentication result of the first user image is an identity authentication success, and if the second feature data does not match the preset feature data, it is obtained that the identity authentication result of the first user image is an identity authentication failure. In some embodiments, before the identity authentication result of the first user image is obtained based on the matching result of the second feature data and the preset feature data, the preset feature data is obtained from a memory. In some embodiments, if the second feature data is an integer face feature vector and the preset feature data is an integer face feature vector, a similarity of the two face feature vectors is determined, and a matching result of the two face feature vectors is determined according to a comparison result between the similarity and a preset similarity threshold. If the similarity is greater than the preset similarity threshold, it is determined that the two face feature vectors match. If the similarity is less than or equal to the preset similarity threshold, it is determined that the two face feature vectors do not match. The preset similarity threshold may be set by a person skilled in the art according to actual requirements or may be a default value, which is not limited in the embodiments of the present disclosure. In the embodiments of the present disclosure, the determination of whether the two face feature vectors are match may be achieved in other approaches, which is not limited in the embodiments of the present disclosure.

In an application scenario of unlocking a terminal device, the first user image is a face image of the user. Accordingly, the first feature data is floating-point face feature data of the user, and the second feature data is integer face feature data of the user. If the integer face feature data of the user matches preset integer face feature data in the terminal device, the user passes the identity authentication, so that the locking of the terminal device can be automatically released. During unlocking the terminal device, there is no need to encrypt and decrypt the integer face feature data, which ensuring security of user information, and meanwhile, computing resources of the terminal device are saved, and the efficiency of identity authentication is improved, thereby optimizing the user experience.

In an application scenario of consumption payment, the first user image is a face image of the user. Accordingly, the first feature data is floating-point face feature data of the user, and the second feature data is integer face feature data of the user. If the integer face feature data of the user matches preset integer face feature data in a server, the user passes the identity authentication, and the terminal device sends a payment request to the server or the server responds to the payment request of the terminal device. During the consumption payment, there is no need to encrypt and decrypt the integer face feature data, so that the security of user information is ensured, the computing resources of the server are saved, and the efficiency of identity authentication is improved, thereby optimizing the user experience.

In some embodiments, the first user image is an image collected during registration of the user. In this case, third feature data of a second user image is further obtained, and an identity authentication result of the second user image is obtained based on a matching result of the third feature data and the second feature data. In some embodiments, the third feature data is feature data obtained after performing quantization processing on the feature data of the second user image. In this case, the second feature data may be further stored to a template database, and the second feature data is obtained from the template database during each identity authentication, but the embodiments of the present disclosure is not limited thereto.

According to the identity authentication method provided in the embodiments, first feature data of an image is obtained and then subjected to quantization processing to obtain second feature data of the image, and an identity authentication result is obtained based on the second feature data of the image. Compared with other approaches, there is no need to encrypt and decrypt feature data during the identity authentication, so that the security of user information is ensured, device computing resources are saved, and the efficiency of identity authentication is improved, thereby optimizing the user experience.

The identity authentication method of the embodiments is executed by any appropriate terminal device or server having image or data processing capabilities, where the terminal device includes, but is not limited to, a camera, a terminal, a mobile terminal, a PC, a server, an in-vehicle device, an entertainment device, an advertising device, a Personal Digital Assistant (PDA), a tablet computer, a laptop computer, a handheld game console, smart glasses, a smart watch, a wearable device, a virtual display device, a display enhanced device (such as Google Glass, Oculus Rift, Hololens, Gear VR), or the like, which is not limited in the embodiments of the present disclosure.

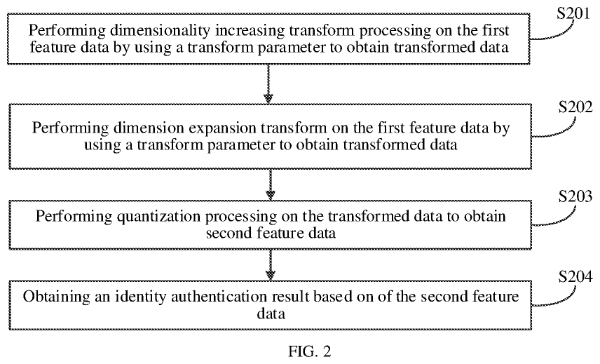

FIG. 2 is a flowchart of the identity authentication method according to other embodiments of the present disclosure.

In operation S201, first feature data of a first user image is obtained. In the embodiments, the first user image is a face image of a user. Accordingly, the first feature data includes a floating-point face feature vector. Since different figures have significantly different face features, performing identity authentication by means of face feature data can ensure the accuracy of identity authentication.

In operation S202, dimensionality increasing transform processing is performed on the first feature data by using a transform parameter to obtain transformed data. In some embodiments, when performing dimensionality increasing transform processing on the first feature data by using a transform parameter, a product of the first feature data and the transform parameter is determined as the transformed data. For example, if the first feature data is a first feature vector and the transform parameter is a transform matrix, the first feature vector is multiplied by the transform matrix to obtain a feature transform vector, and in this case, the transformed data is the feature transform vector. It should be understood that the foregoing descriptions are merely exemplary. In some embodiments, dimension expansion can also be performed on the first feature data in other approaches, which is not limited in the embodiments of the present disclosure.

In some embodiments, the transform parameter is predetermined; that is to say, the transform parameter needs to be determined before performing dimensionality increasing transform processing on the first feature data by using the transform parameter. For example, the transform parameter is defined manually, determined by means of a specific computing rule, obtained by means of training or the like. For example, the transform parameter is initialized, and then iterative update is performed on the initiated transform parameter based on at least one piece of sample feature data until an iteration termination condition is met. In some embodiments, the at least one piece of sample feature data is obtained from other devices, or the at least one piece of sample feature data is obtained by separately performing feature extraction on each of at least one sample image. The obtaining of the sample feature data and the initialization are executed concurrently or in any sequential order, which is not limited in the embodiments of the present disclosure.

In some embodiments, the iteration termination condition includes: a difference value between the transform parameter after the update and the transform parameter before the update is smaller than or equal to a preset difference value, a number of times the iteration performed reaches a preset threshold, or a combination thereof, where the preset difference value and the preset threshold may be set by a person skilled in the art according to actual requirements or be default values, which is not limited in the embodiments of the present disclosure. In one example, in the case that the transform parameter is the transform matrix, the iteration termination condition includes: a Hamming distance value between a transform matrix after the update and a transform matrix before the update is less than or equal to a present Hamming distance value. For example, elements at corresponding positions of the transform matrix after update and the transform matrix before update are compared; if the elements are identical, the Hamming distance at the corresponding positions is 0, and if the elements are not identical, the Hamming distance at the corresponding positions is 1; the Hamming distance values at all positions in the matrices are accumulated to obtain the Hamming distance value between the transform matrix after update and the transform matrix before update. It can be understood that no limitation is made in the embodiments of the present disclosure, and any iteration termination condition for obtaining the transform matrix via iterative update is applicable to the embodiments, the embodiments is not limited thereto. For example, when the number of times the iteration is performed reaches an iteration termination number of times, the transform matrix obtained in the last iterative update is used as the transform matrix obtained via the iterative update.

In some embodiments, when initializing the transform parameter, the transform parameter is initialized by means of a Gaussian random function. For example, when the transform parameter includes the transform matrix, the number of rows and the number of columns of the transform matrix are used as input parameters of the Gaussian random function, and then the transform matrix is initialized by the Gaussian random function according to the number of rows and the number of columns of the transform matrix. In some embodiments, the number of rows and the number of columns of the initialized transform matrix are equal, and the number of rows and the number of columns are both greater than the dimension of a first transform parameter, but the embodiments of the present disclosure are not limited thereto, where the data type of the elements in the transform matrix obtained via the initialization is floating-point.

In some embodiments, the number of rows of the transform matrix is the dimension of the first feature data and the number of columns of the transform matrix is the dimension of second feature data, and the dimension of the second feature data is an integer multiple of the dimension of the first feature data. That is to say, the number of columns of the transform matrix is an integer multiple of the number of rows of the transform matrix. For example, if the first feature data is a 256-dimension feature vector and the transformed data is a 1024-dimension feature transform vector, then the number of rows and the number of columns of the transform matrix are respectively 256 and 1024, and the number of columns of the transform matrix is 4 times of the number of rows, but the embodiments of the present disclosure are not limited thereto.

In some embodiments, when separately performing feature extraction on each of at least one sample image, feature extraction may be separately performed on each of the at least one sample image by means of a neural network for feature extraction to obtain at least one piece of sample feature data. In some embodiments, the sample feature data includes a sample feature vector, where a data type of the elements in the sample feature vector is floating-point, and the dimension of the sample feature vector is determined according to the use of the transform matrix. For example, when the transform matrix is used for transforming a 128-dimension face feature vector to a 512-dimension face feature vector, the dimension of a face sample feature vector for iterative update of the transform matrix is 128. When the transform matrix is used for transforming a 256-dimension face feature vector to a 1024-dimension face feature vector, the dimension of a face sample feature vector for transform matrix iterative update is 256. That is to say, the dimension of the sample feature data for transform matrix iterative update is identical to the dimension of the first feature data. It can be understood that no limitation is made in the embodiments, any implementation of obtaining sample feature data from a sample image is applicable to the embodiment, which is not limited in the embodiments.

In some embodiments, when performing iterative update on the initialized transform parameter based on the at least one piece of sample feature data, each update is performed in the following way: separately performing dimensionality increasing transform processing on each of the at least one piece of sample feature data based on the current transform parameter to obtain at least one piece of transformed sample feature data; separately performing quantization processing on each of the at least one piece of transformed sample feature data to obtain at least one piece of quantized sample feature data; and updating the current transform parameter based on the at least one piece of quantized sample feature data and the at least one piece of sample feature data.

In some embodiments, a first sample feature matrix is first constructed according to at least one sample feature vector, and then iterative update is performed on the initialized transform matrix based on the first sample feature matrix. In some embodiments, dimensionality increasing transform processing is separately performed on each sample feature vector in the first sample feature matrix based on the current transform matrix to obtain a sample feature transform matrix constructed by sample feature transform vectors, quantization processing is separately performed on each sample feature transform vector in the sample feature transform matrix to obtain quantized sample feature vectors to construct a second sample feature matrix, and then the current transform matrix is updated based on the first sample feature matrix and the second sample feature matrix. In one example, each sample feature vector in the first sample feature matrix is separately subjected to dimensionality increasing transform processing and quantization processing according to formula 1 below:

B=sign(XR) Formula 1,

where X represents the first sample feature matrix, R represents the transform matrix, sign(*) represents a sign function, and B represents the second sample feature matrix. The data type of each element in matrix X is the floating-point, the data type of each element in matrix R is the floating-point, and quantization processing is separately performed on each element in a matrix obtained after multiplication by using the sign function. For example, if the value of an element in the matrix is greater than zero, the value of the element is quantized as 1, and otherwise, the value of the element is quantized as 0, but the embodiments of the present disclosure are not limited hereto.

In some embodiments, when updating the current transform parameter based on the at least one piece of quantized sample feature data and the at least one piece of sample feature data, the second sample feature matrix is transposed to obtain a transposed second sample feature matrix, the transposed second sample feature matrix is multiplied by the first sample feature matrix to obtain a multiplied matrix, singular value decomposition processing is performed on the multiplied matrix to obtain a first orthogonal matrix and a second orthogonal matrix, and a transform matrix is updated based on the first orthogonal matrix and the second orthogonal matrix, where the first sample feature matrix includes at least one piece of sample feature data, and the second sample feature matrix includes at least one piece of quantized sample feature data.

In some embodiments, the number of rows or columns of the first orthogonal matrix is equal to the dimension of the second feature data, and the number of columns or rows of the second orthogonal matrix is equal to the dimension of the first feature data. In this case, in some embodiments, when updating a transform matrix based on the first orthogonal matrix and the second orthogonal matrix, the first orthogonal matrix is intercepted to obtain an intercepted first orthogonal matrix, and the second orthogonal matrix is multiplied by the intercepted first orthogonal matrix to obtain an updated transform matrix.

In one example, if the dimensions of the first sample feature matrix is n×256 and the second sample feature matrix is a n×1024 matrix, the matrix obtained by multiplying the transposed second sample feature matrix and the first sample feature matrix is a 1024×256 matrix; the multiplied matrix is subjected to singular value decomposition processing to obtain a 1024×1024 first orthogonal matrix, a 256×256 second orthogonal matrix, and a 256×1024 diagonal matrix. Then, the transform matrix is updated according to the 1024×1024 first orthogonal matrix and the 256×256 second orthogonal matrix. For example, the 1024×1024 first orthogonal matrix is first transversely intercepted to obtain a 256×1024 intercepted first orthogonal matrix, and then the 256×256 second orthogonal matrix is multiplied by the 256×1024 intercepted first orthogonal matrix to obtain an update result of the transform matrix.

In operation S203, quantization processing is performed on the transformed data to obtain the second feature data.

In the embodiments of the present disclosure, quantization processing may be directly performed on the first feature data, or, the first feature data is subjected to one or more processing, and the quantization processing is then performed on the processed first feature data.

In the embodiments, the transformed data is obtained by performing dimensionality increasing transform processing on the first feature data with a transform parameter. The quantization processing is performed on the transformed data to obtain the second feature data. In this way, it is guaranteed that the second feature data represent image features represented by the first feature data as completely as possible, and the accuracy of data processing is improved.

In operation S204, an identity authentication result is obtained based on the second feature data.

Operation S204 is the same as operation S103, and thus details are not described herein repeatedly.

According to the technical solution provided in the embodiments of the present disclosure, first feature data of an image is obtained and then subjected to dimensionality increasing transform processing to obtain transformed data of the image, quantization processing is performed on the transformed data of the image to obtain second feature data of the image, and then an identity authentication result is obtained based on the second feature data of the image. Compared with other approaches, there is no need to encrypt and decrypt feature data during identity authentication, so that the security of user information is ensured, device computing resources are saved, and the efficiency of identity authentication is improved, thereby optimizing the user experience. In addition, the accuracy of identity authentication can also be improved. The identity authentication method of the embodiments is executed by any appropriate terminal device or server having image or data processing capabilities, where the terminal device includes but is not limited to: a camera, a terminal, a mobile terminal, a PC, a server, an in-vehicle device, an entertainment device, an advertising device, a Personal Digital Assistant (PDA), a tablet computer, a laptop computer, a handheld game console, smart glasses, a smart watch, a wearable device, a virtual display device, a display enhanced device (such as Google Glass, Oculus Rift, Hololens, Gear VR), and the like, which is not limited in the embodiments of the present disclosure.

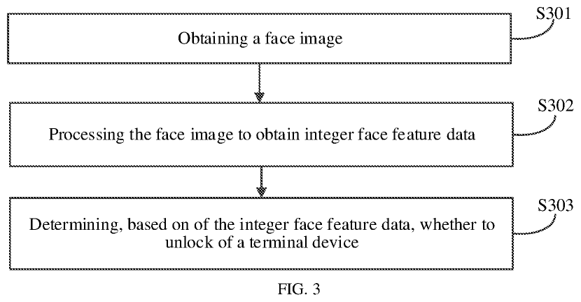

FIG. 3 is a flowchart of an unlocking method according to some embodiments of the present disclosure.

In operation S301, a face image is obtained.

In the embodiments of the present disclosure, the face image is obtained under the condition that a terminal device is locked. In some embodiments, a camera of the terminal device obtains the face image of a user in response to an unlocking instruction of the user to the terminal device, or a server receives the face image sent by the terminal device, where the camera of the terminal device obtains a front face image or face images in other postures of the user, which is not limited in the embodiments of the present disclosure. Or, the face image is obtained in the case that it is determined that an unlocking procedure for the terminal device is required, which is not limited in the embodiments of the present disclosure.

In operation S302, the face image is processed to obtain integer face feature data.

In some embodiments, feature extraction is first performed on the face image to obtain floating-point face feature data, and then quantization processing is performed on the floating-point face feature data to obtain the integer face feature data (which can also be referred to as first integer face feature data). In some embodiments, feature extraction is first performed on the face image to obtain the floating-point face feature data, then dimensionality increasing transform processing is performed on the floating-point face feature data to obtain float face feature transformed data, and finally, quantization processing is performed on the floating-point face feature transformed data to obtain the integer face feature data. In some embodiments, the integer face feature data can also be obtained in other approaches, which is not limited in the embodiments of the present disclosure.

In operation S303, whether to unlock the terminal device is determined based on the integer face feature data.

In some embodiments, whether the integer face feature data matches preset face feature data is determined, and when it is determined that the integer face feature data matches the preset face feature data, the locking of the terminal device is released.

In some embodiments, if the method is executed by a server and it is determined in S303 that the locking of the terminal device is released, the unlocking instruction is sent to the terminal device, which is not limited in the embodiments of the present disclosure. In some embodiments, after unlocking the terminal device, a display screen of the terminal device is transformed from a locked interface to a user unlocking interface, which, for example, displays an application list or a user-defined or default unlocking interface image, and a user is enabled with the authority of using some or all applications of the terminal device, which is not limited in the embodiments of the present disclosure.

In the embodiments of the present disclosure, the preset face feature data is a feature vector stored in the terminal device or server, and the presser face feature data is an integer feature vector. In one example, a similarity between the integer face feature data and the preset face feature data is determined, and the similarity is compared with a preset threshold, where in the case that the similarity is greater than or equal to the present threshold, it is determined that the integer face feature data matches the preset face feature data. However, the embodiments of the present disclosure determine whether to match in other approaches, which is not limited in the embodiments of the present disclosure.

In some embodiments, before S301, the method further includes: obtaining a second face image, processing the second face image to obtain second integer face feature data, and storing the second integer face feature data into a template database. In some embodiments, after obtaining the face image, the terminal device or server directly performs feature extraction, or determines whether the obtained face image meets a preset image condition before performing feature extraction, where the preset image condition includes one or more of the following: image quality meeting a preset quality condition, being at an eye-opened state, a face posture meeting a preset posture condition, being at a mouth-closed state, the size of a face area meeting a preset size condition, a shielded part in the face area meeting a preset shielding condition, an image illumination condition meeting a preset illumination condition, or the like. For example, eye opening/closing detection is performed on the face image to determine the state of at least one of two eyes; in this case, if it is determined that the two eyes are both at the closed state, it is determined that the face image does not meet the preset image condition, so as to prevent the user in a sleep state from being subjected to unauthorized identity authentication by others, and accordingly, if it is determined that the two eyes are both in the opened state or at least one eye is in the opened state, it can be determined that the face image meets the preset image condition. For another example, mouth opening and closing detection can be performed on the face image, and it is determined that the face image meets the preset image condition only in the case of the mouth closed state. For another example, it is determined that the face image meets the preset image condition only in the case that the face posture in the face image is a front face or a deviation angle between the face posture and the front face in one or more of three directions is within a preset range, where the three directions are directions corresponding to a roll-pitch-raw coordinate system or other types of coordinate systems. For another example, the size of the face area (such as the size of a face) in the face image is determined, where the size is a pixel size or a proportional size, and it is determined that the preset image condition is met only when the size of the face area exceeds the preset size threshold; as one example, if the face area occupies 60% of the face image, which is higher than preset 50%, then it is determined that the face image meets the preset image condition. For another example, whether the face area in the face image is shielded, a shielding proportion, or whether a specific part or area is shielded is determined, and whether the face images meets the preset image condition is determined based on the determination result. For another example, whether an illumination condition of the face image meets the preset illumination condition can be determined, and it is determined that the face image does not meet the preset image condition in the case of dark illumination. For another example, the image quality of the face image can be determined, such as whether the face image is clear. Or other conditions can also be included, which is not limited in the embodiments of the present disclosure. In this case, the face image is processed only when it is determined that the face image meets the preset image condition, so as to obtain the integer face feature data, which is not limited in the embodiments of the present disclosure.

In some embodiments, the second face image is processed in an approach similar to that for the face image (which can also be referred to as the first face image) obtained in S301, so as to obtain second integer face feature data. In this way, the preset face feature data stored in the template database is also the integer face feature data, so as to achieve face registration of the user to provide an authentication basis for a subsequent face unlocking procedure.

According to the unlocking method provided in the embodiments, a face image is obtained and then processed to obtain integer face feature data; and then whether to unlock a terminal device is determined based on the integer face feature data. Compared with other approaches, there is no need to encrypt and decrypt face feature data during terminal device unlocking, so that the security of user information is ensured, the computing resources are saved, and the efficiency of identity authentication is improved, thereby optimizing the user experience.

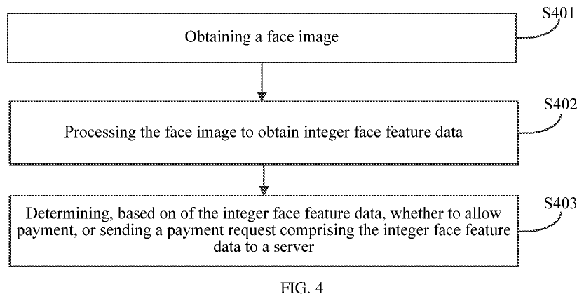

FIG. 4 is a flowchart of a payment method according to some embodiments of the present disclosure.

In operation S401, a face image is obtained.

In the embodiments of the present disclosure, a camera of a terminal device obtains the face image in response to a payment instruction of a user, or a server receives the face image sent by the terminal device, or the face image is obtained in other situations where it is determined that a payment operation is required, which is not limited in the embodiments of the present disclosure. In some embodiments, the obtaining a face image includes: obtaining the face image in response to reception of the payment instruction of the user.

In operation S402, the face image is processed to obtain integer face feature data.

In some embodiments, feature extraction is first performed on the face image to obtain floating-point face feature data, and then quantization processing is performed on the floating-point face feature data to obtain the integer face feature data.

In some embodiments, feature extraction is first performed on the face image to obtain the floating-point face feature data of the user, dimensionality increasing transform processing is performed on the floating-point face feature data to obtain face feature transformed data, and then quantization processing is performed on the face feature transformed data to obtain the integer face feature data.

In operation S403, a payment request including the integer face feature data is sent to the server, or, whether to allow payment is determined based on the integer face feature data.

In the embodiments of the present disclosure, the terminal device sends to the server the payment request including the integer face feature data, and for example, the payment request further includes a payment amount and/or user identifier information, etc., which is nit limited in the embodiments of the present disclosure. Generally, the terminal device uses the integer face feature data as a password and sends same to the server, so that the server authenticates a current transaction according to the integer face feature data. Or, the terminal device determines, based on the integer face feature data, whether to allow payment. In some embodiments, the method is also executed by the server. In this case, after obtaining the integer face feature data, the server determines, based on the integer face feature data, whether to allow payment. For example, when it is determined that the integer face feature data matches preset face feature data (such as locally stored integer face feature data), the server or terminal device allows payment, and deducts a transaction amount from an account associated with the preset face feature data.

In some embodiments, after obtaining the face image, the terminal device or server directly performs feature extraction, or determines whether the obtained face image meets a preset image condition before performing feature extraction, where the preset image condition includes at least one of: image quality meets a preset quality condition, a face in the image is in an eye opened state, a face posture meets a preset posture condition, the face in the image is in a mouth closed state, the size of a face area meets a preset size condition, a shielded part in the face area meets a preset shielding condition, or an image illumination condition meets a preset illumination condition. For example, if a deviation between the face posture of the obtained face image and a front direction is not within a preset range, such as greater than 20 degrees, it is determined that the face image does not meet the preset image condition. For another example, if an image resolution of the face image is lower than a preset resolution, 1024×720, it is determined that the face image does not meet the preset image condition. For another example, if two eyes of a figure in the face image are both in a closed state, it can be determined that the face image does not meet the preset image condition. In this case, the face image is processed only when it is determined that the face image meets the preset image condition, so as to obtain the integer face feature data, which is not limited in the embodiments of the present disclosure.

In some embodiments, before S401, the method further includes: obtaining a second face image, and processing the second face image to obtain second integer face feature data; and storing the second integer face feature data into a template database, or sending a face payment registration request including the second integer face feature data to the server.

In some embodiments, the second face image is processed in an approach similar to that for the face image (which can also be referred to as the first face image) obtained in S401, so as to obtain the second integer face feature data.

After receiving the face payment registration request sent by the terminal device, the server stores the second integer face feature data and uses the second integer face feature data as an authentication basis for transaction payment. In addition, the server also sends a face payment registration response to the terminal device to indicate whether face payment registration succeeds.

In some embodiments, operation S404 is further included. In operation S404, the terminal device receives the payment response for the payment request from the server. In the embodiments of the present disclosure, the terminal device receives the payment response corresponding to the payment request from the server so as to notify whether the payment request is allowed.

According to the payment method provided in the embodiments, a face image is obtained; the face image is processed to obtain integer face feature data; and a payment request including the integer face feature data is sent to a server or whether to allow payment is determined based on the integer face feature data. Compared with other approaches, there is no need to encrypt and decrypt face feature data during consumption payment, so that the security of user information is ensured, the computing resources are saved, and the efficiency of identity authentication is improved, thereby optimizing the user experience.

In any embodiments above of the present disclosure, the obtaining a face image includes: performing image collection by means of the camera to obtain the face image. The performing image collection by means of the camera to obtain the face image includes: performing image collection by means of the camera to obtain a video stream; and performing frame selection on a multi-frame image included in the video stream to obtain the face image. The face image is obtained by performing face detection on an original image.

A face feature is generally stored in the format of floating-point. In face unlocking, face payment and other face recognition technologies, it is necessary to encrypt and decrypt the face feature in the terminal device; however, such encryption and decryption will consume a lot of time and resources. The embodiments of the present disclosure perform binary quantization on the extracted floating-point face feature, i.e., a floating-point feature is transformed as a binary feature consisting of 0 and/or 1, so as to solve the problem. In some embodiments, a 128- or 256-dimension float feature (i.e., the face feature) is extracted from the face image, the extracted face feature is subjected to iterative quantization training to generate a feature transform matrix R, and the corresponding face feature of the face image is transformed to the binary feature by means of the transform matrix R, such that there is no need to encrypt and decrypt the face feature during information transmission in the terminal device, thereby saving the computing time and resources.

Quantization relates to performing quantization processing on an original floating-point feature as an integer feature, such that even the feature vector remains the same, it will lose some precision. In order to solve the prevision problem after quantization (i.e., in order to ensure that the quantized feature will not lose information before quantization), in some embodiments, an iterative quantization algorithm is further optimized. Specifically, the quantized binary feature is subjected to a dimension expansion operation, for example, a 512 -or 1024-dimension integer feature is used to represent an original 128- or 256-dimension floating-point feature. Generally, quantization is applied in the field of image searching, and a dimension reduction operation is used. However, in the embodiments of the present disclosure, information carried in the quantized feature can be enriched by means of the dimension expansion operation, thereby improving the accuracy of face recognition.

The descriptions of the embodiments in the present text focus on differences between the embodiments, and for same or similar parts in the embodiments, refer to these embodiments. For example, the descriptions of the embodiments corresponding to FIGS. 1 and 2 are also applicable to the embodiments corresponding to FIGS. 3 and 4. For the purpose of brevity, details are not described again.

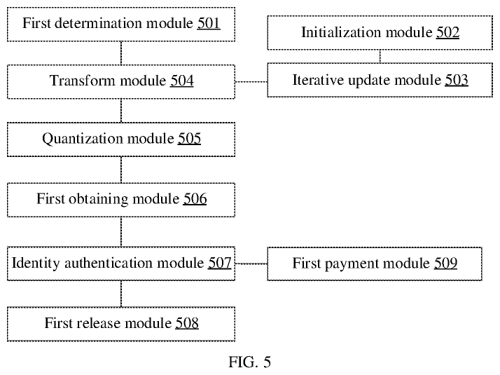

FIG. 5 is a structural block diagram of an identity authentication apparatus according to some embodiments of the present disclosure, based on the same technical concept. The identity authentication apparatus can be used to implement the flow of the identity authentication method according to the foregoing embodiments.

Referring to FIG. 5, the identity authentication apparatus includes a first termination module 501, a quantization module 505, and an identity authentication module 507. The first determination module 501 is configured to obtain first feature data of a first user image; the quantization module 505 is configured to quantize the first feature data to obtain second feature data; and the identify authentication module 507 is configured to obtain an identity authentication result based on the second feature data.

By means of the identity authentication apparatus provided in the embodiments, first feature data of an image is determined and then quantized to obtain second feature data of the image, and an identity authentication result is obtained based on the second feature data of the image. Compared with other approaches, there is no need to encrypt and decrypt feature fata during identity authentication, so that the security of user information is ensured, device computing resources are saved, and the efficiency of identity authentication is improved, thereby optimizing the user experience.

In some embodiments, the quantization module 505 is configured to: quantize the first feature data by using a sign function to obtain the second feature data. In some embodiments, before the quantization module 505, the apparatus further includes: a transform module 504 configured to perform dimensionality increasing transform processing on the first feature data by using a transform parameter to obtain transformed data; and the quantization module 505 is configured to: quantize the transformed data to obtain the second feature data.

In some embodiments, the transform module 504 is configured to: determine a product of the first feature data and the transform parameter as the transformed data. In some embodiments, before the transform module 504, the apparatus further includes: an initialization module 502 configured to initialize the transform parameter; and an iterative update module 503 configured to perform iterative update on the initialized transform parameter based on at least one piece of sample feature data until an iteration termination condition is met. In some embodiments, the iteration termination condition includes: a difference value between the transform parameter after the update and the transform parameter before the update is smaller than or equal to a preset difference value.

In some embodiments, the transform parameter includes a transform matrix, and the number of columns of the transform matrix is an integer multiple of the number of rows. In some embodiments, the identity authentication module 507 is configured to: obtain the identity authentication result of the first user image based on a matching result of the second feature data and preset feature data. In some embodiments, before the identity authentication module 507, the apparatus further includes: a first obtaining module 506 configured to obtain the preset feature data from a memory, the preset feature data being a binary numerical sequence. In some embodiments, the apparatus further includes: a first release module 508 configured to, if the identity authentication result is a pass, unlock a terminal device. In some embodiments, the apparatus further includes: a first payment module 509 configured to, if the identity authentication result is a pass, send a payment request to a server or respond to the payment request.

In some embodiments, the first determination module 501 includes: an obtaining unit configured to obtain the first user image; and an extraction unit configured to perform feature extraction on the first user image to obtain the first feature data of the first user image. In some embodiments, the second feature data includes a binary numerical sequence. In some embodiments, the dimension of the second feature data is greater than the dimension of the first feature data. In some embodiments, the first user image is a face image of a user. In some embodiments, the obtaining unit is configured to: perform image collection by means of a camera to obtain the first user image; or receive a request message carrying the first user image sent by the terminal device. In some embodiments, the first termination module is configured to: receive a request message carrying the first feature data of the first user image sent by the terminal device. In some embodiments, the apparatus further includes a sending module, configured to send a response message indicating the identity authentication result to the terminal device.

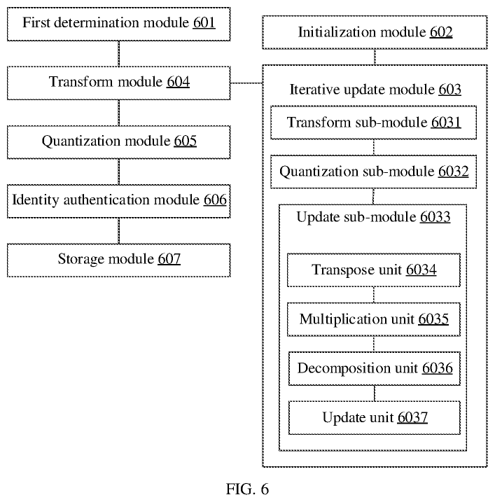

FIG. 6 is a structural block diagram of an identity authentication apparatus according to other embodiments of the present disclosure, based on the same technical concept. The identity authentication apparatus can be used to implement the flow of the identity authentication method according to the foregoing embodiments.

Referring to FIG. 6, the identity authentication apparatus includes a first termination module 601, a quantization module 605, and an identity authentication module 606. The first determination module 601 is configured to obtain first feature data of a first user image; the quantization module 605 is configured to quantize the first feature data to obtain second feature data; and the identify authentication module 606 is configured to obtain an identity authentication result based on the second feature data.

In some embodiments, before the quantization module 605, the apparatus further includes: a transform module 604 configured to perform dimensionality increasing transform processing on the first feature data by using a transform parameter to obtain transformed data; and the quantization module 605 is configured to: quantize the transformed data to obtain the second feature data.

In some embodiments, the transform module 604 is configured to: determine a product of the first feature data and the transform parameter as the transformed data. In some embodiments, before the transform module 604, the apparatus further includes: an initialization module 602 configured to initialize the transform parameter; and an iterative update module 603 configured to perform iterative update on the initialized transform parameter based on at least one piece of sample feature data until an iteration termination condition is met. In some embodiments, the initialization module 602 is configured to: initialize the transform parameter by means of a Gaussian random function.

In some embodiments, the iterative update module 603 includes: a transform sub-module 6031 configured to separately perform dimensionality increasing transform processing on each of the at least one piece of sample feature data based on the current transform parameter to obtain at least one piece of transformed sample feature data; a quantization sub-module 6032 configured to separately quantize each of the at least one piece of transformed sample feature data to obtain at least one piece of quantized sample feature data; and an update sub-module 6033 configured to update the current transform parameter based on the at least one piece of quantized sample feature data and the at least one piece of sample feature data.

In some embodiments, the at least one piece of sample feature data is a first sample feature matrix, and the at least one piece of quantized sample feature data is a second sample feature matrix. The update sub-module 6033 includes: a transpose unit 6034 configured to transpose the second sample feature matrix to obtain a transposed second sample feature matrix; a multiplication unit 6035 configured to multiply the transposed second sample feature matrix and the first sample feature matrix to obtain a multiplied matrix; a decomposition unit 6036 configured to perform singular value decomposition processing on the multiplied matrix to obtain a first orthogonal matrix and a second orthogonal matrix; and an update unit 6037 configured to update a transform matrix based on the first orthogonal matrix and the second orthogonal matrix.

In some embodiments, the update unit 6037 is configured to: intercept the first orthogonal matrix to obtain an intercepted first orthogonal matrix, and multiply the second orthogonal matrix and the intercepted first orthogonal matrix to obtain an updated transform matrix. In some embodiments, the identity authentication module 606 is configured to: obtain third feature data of a second user image; and obtain an identity authentication result of the second user image based on a matching result of the third feature data and the second feature data. In some embodiments, the apparatus further includes: a storage module 607 configured to store the second feature data into a template database.

The identity authentication apparatus is used for implementing the identity authentication method according to any optional embodiments, and accordingly, the identity authentication apparatus includes units or modules for implementing the operations in the identity authentication method.

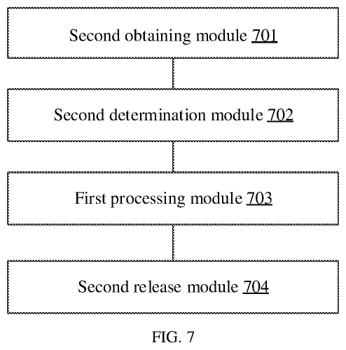

FIG. 7 is a structural block diagram of an unlocking apparatus according to some embodiments of the present disclosure, based on the same technical concept. The unlocking apparatus can be used to implement the flow of the unlocking method according to the foregoing embodiments.

Referring to FIG. 7, the unlocking apparatus includes a second obtaining module 701, a first processing module 703, and a second release module 704. The second obtaining module 701 is configured to obtain a face image; the first processing module 703 is configured to process the face image to obtain integer face feature data; and the second release module 704 is configured to determine, based on the integer face feature data, whether to unlock a terminal device.

By means of the unlocking apparatus provided in the embodiments, a face image is obtained and then processed to obtain integer face feature data; and then whether to unlock a terminal device is determined based on the integer face feature data. Compared with other approaches, there is no need to encrypt and decrypt face feature data during terminal device unlocking, so that the security of user information is ensured, the computing resources are saved, and the efficiency of identity authentication is improved, thereby optimizing the user experience.

In some embodiments, the second obtaining module 701 is configured to: obtain the face image in response to an unlocking instruction of a user. In some embodiments, the first processing module 703 is configured to: perform feature extraction on the face image to obtain floating-point face feature data; and quantize the floating-point face feature data to obtain the integer face feature data. In some embodiments, the integer face feature data includes a binary numerical sequence. In some embodiments, before the first processing module 703, the apparatus further includes: a second determination module 702 configured to determine whether the face image meets a preset image requirement; and the first processing module 703 is configured to: in the case that the face image meets the preset image requirement, process the face image to obtain the integer face feature data. In some embodiments, the second release module 704 is configured to: determine, based on whether the integer face feature data matches preset face feature data, whether to unlock the terminal device, where the preset face feature data is integer data. In some embodiments, a third obtaining module is configured to: obtain the face image in response to a payment instruction of the user. The unlocking apparatus is used for implementing the unlocking method, and accordingly, the unlocking apparatus includes units or modules for implementing the operations in the unlocking method.

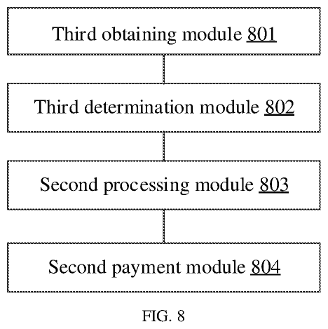

FIG. 8 is a structural block diagram of a payment apparatus according to some embodiments of the present disclosure, based on the same technical concept. The payment apparatus can be used to implement the flow of the payment method according to the foregoing embodiments.

Referring to FIG. 8, the payment apparatus includes a third obtaining module 801, a second processing module 803, and a second payment module 804. The third obtaining module 801 is configured to obtain a face image; the second processing module 803 is configured to process the face image to obtain integer face feature data; and the second payment module 804 is configured to determine, based on the integer face feature data, whether to allow payment, or send a payment request including the integer face feature data to a server. By means of the payment apparatus provided in the embodiments, a face image is obtained; the face image is processed to obtain integer face feature data; and a payment request including the integer face feature data is sent to a server or whether to allow payment is determined based on the integer face feature data. Compared with other approaches, there is no need to encrypt and decrypt face feature data during consumption payment, so that the security of user information is ensured, the computing resources are saved, and the efficiency of identity authentication is improved, thereby optimizing the user experience.

In some embodiments, the second processing module 803 is configured to: perform feature extraction on the face image to obtain floating-point face feature data; and quantize the floating-point face feature data to obtain the integer face feature data. In some embodiments, the integer face feature data includes a binary numerical sequence. In some embodiments, before the second processing module 803, the apparatus further includes: a third determination module 802 configured to determine whether the face image meets a preset image requirement; and the second processing module 803 is configured to: in the case that the face image meets the preset image requirement, process the face image to obtain the integer face feature data.

The payment apparatus is used for implementing the payment method, and accordingly, the payment apparatus includes units or modules for implementing the operations in the payment method. According to the embodiments of the present disclosure, another unlocking apparatus is provided. The apparatus includes: a camera configured to collect a face image; and a processor configured to process the face image to obtain integer face feature data, and determine, based on the integer face feature data, whether to unlock a terminal device. In some embodiments, the unlocking apparatus is used for implementing the unlocking method, and accordingly, the unlocking apparatus includes modules or devices for implementing the operations in the unlocking method.

According to the embodiments of the present disclosure, a payment apparatus is provided. The apparatus includes: a camera configured to collect a face image; and a processor configured to process the face image to obtain integer face feature data, and determine, based on the integer face feature data, whether to allow payment. According to the embodiments of the present disclosure, a payment apparatus is provided. The apparatus includes: a camera configured to collect a face image; a processor configured to process the face image to obtain integer face feature data; and a transceiver configured to send a payment request including the integer face feature data to a server.

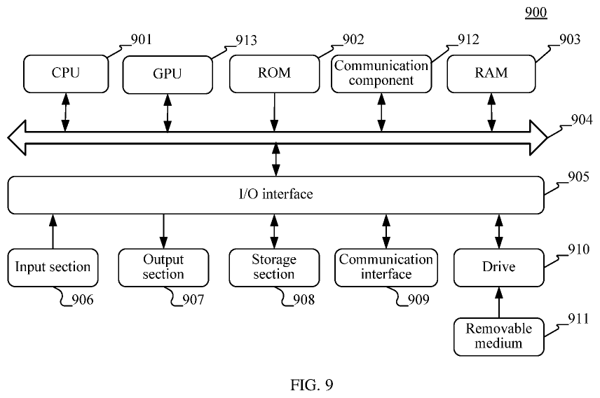

The embodiments of the present disclosure further provide an electronic device, such as a mobile terminal, a Personal Computer (PC), a tablet computer, and a server. Referring to FIG. 9 below, a schematic structural diagram of an electronic device 900 adapted to implement a terminal device or a server according to the embodiments of the present disclosure is shown. As shown in FIG. 9, the electronic device 900 includes one or more first processors, a communication element, and the like. The one or more first processors are, for example, one or more Central Processing Units (CPUs) 901 and/or one or more Graphic Processing Units (GPUs) 913, and the first processors may execute various appropriate actions and processing according to executable instructions stored in a Read-Only Memory (ROM) 902 or executable instructions loaded from a storage section 908 to a Random Access Memory (RAM) 903. In the embodiments, the first ROM 902 and the RAM 903 are collectively referred to as a first memory. The communication element includes a communication component 912 and/or a communication interface 909. The communication component 912 may include, but not limited to, a network card and the network card may include, but not limited to, an InfiniBand (IB) network card. The communication interface 909 includes a communication interface of a network interface card such as a LAN card and a modem, and the communication interface 909 performs communication processing via a network such as the Internet.

The first processors communicate with the ROM 902 and/or the RAM 903 to execute executable instructions, are connected to the communication component 912 by means of the first communication bus 904, and communicate with other target devices by means of the communication component 912, so as to complete operations corresponding to any identity authentication method provided in the embodiments of the present disclosure, such as obtaining first feature data of a first user image, performing quantization processing on the first feature data to obtain second feature data, and obtaining an identity authentication result based on the second feature data.

In addition, the RAM 903 may further store various programs and data required for operations of the apparatuses. The CPU 901 or GPU 913, the ROM 902, and the RAM 903 are connected to each other by means of the first communication bus 904. In the presence of the RAM 903, the ROM 902 is an optional module. The RAM 903 stores executable instructions, or writes the executable instructions to the ROM 902 during running, where the executable instructions enable the first processors to perform corresponding operations of the foregoing communication method. An input/output (I/O) interface 905 is also connected to the first communication bus 904. The communication component 912 may be an integrated component, or may include multiple sub-modules (e.g., multiple IB network cards), and is linked with the communication bus.

The following parts are connected to the I/O interface 905: an input section 906 including a keyboard, a mouse and the like; an output section 907 including a Cathode-Ray Tube (CRT), a Liquid Crystal Display (LCD), a loudspeaker and the like; the storage section 908 including hardware and the like; and the communication interface 909 of a network interface card such as a LAN card and a modem. A drive 910 is also connected to the I/O interface 905 according to needs. A removable medium 911 such as a disk, an optical disk, a photo-magnetic disk and a semiconductor memory is installed on the drive 910 according to needs, to cause a computer program read from the removable medium 911 to be installed into the storage section 908 according to needs.

It should be noted that the architecture illustrated in FIG. 9 is merely an optional implementation mode. During practice, the number and types of the parts in FIG. 9 may be selected, decreased, increased, or replaced according to actual requirements. Different functional parts may be separated or integrated or the like. For example, the GPU and the CPU may be separated, or the GPU may be integrated on the CPU, and the communication element may be separated from or integrated on the CPU or the GPU or the like. These alternative implementations all fall within the scope of protection of the present disclosure.

Particularly, the process described above with reference to the flowchart according to the embodiments of the present disclosure is implemented as a computer software program.

For example, the embodiments of the present disclosure provide a computer program product, which includes a computer program tangibly included in a machine-readable medium. The computer program includes a program code for executing a method shown in the flowchart. The program code may include corresponding instructions for correspondingly executing operations of the methods provided by the embodiments of the present disclosure, such as obtaining first feature data of a first user image, performing quantization processing on the first feature data to obtain second feature data, and obtaining an identity authentication result based on the second feature data. In the embodiments, the computer program may be downloaded from a network by means of the communication element and installed, and/or be installed from the removable medium 911. When the computer program is executed by the first processor, the functions defined in the method according to the embodiments of the present disclosure are executed.

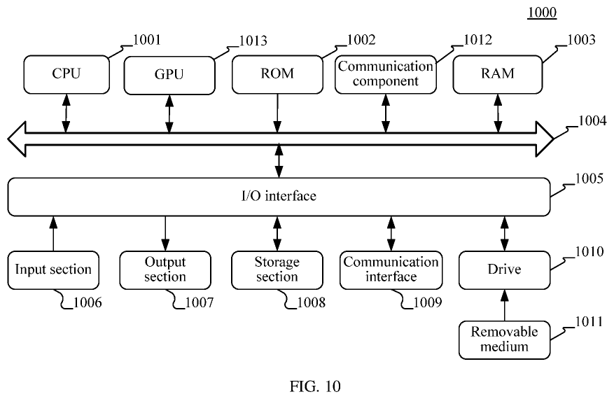

The embodiments of the present disclosure further provide an electronic device, such as a mobile terminal, a Personal Computer (PC), a tablet computer, and a server. Referring to FIG. 10 below, a schematic structural diagram of an electronic device 1000 adapted to implement a terminal device or a server according to the embodiments of the present disclosure is shown. As shown in FIG. 10, the electronic device 1000 includes one or more second processors, a second communication element, and the like. The one or more second processors are, for example, one or more Central Processing Units (CPUs) 1001, and/or one or more Graphic Processing Units (GPUs) 1013, and the like. The second processors may perform various appropriate actions and processing according to executable instructions stored in a Read-Only Memory (ROM) 1002 or executable instructions loaded from a storage section 1008 to a Random Access Memory (RAM) 1003. In the embodiments, the second ROM 1002 and the RAM 1003 are collectively referred to as a second memory. The second communication element includes a communication component 1012 and/or a communication interface 1009. The communication component 1012 may include, but not limited to, a network card and the network card may include, but not limited to, an InfiniBand (IB) network card. The communication interface 1009 includes a communication interface of a network interface card such as a LAN card and a modem, and the communication interface 1009 performs communication processing via a network such as the Internet.

The second processors communicate with the ROM 1002 and/or the RAM 1003 to execute executable instructions, are connected to the communication component 1012 by means of the second communication bus 1004, and communicate with other target devices by means of the communication component 1012, so as to complete operations corresponding to any unlocking method provided in the embodiments of the present disclosure, such as obtaining a face image, processing the face image to obtain integer face feature data, and determining, based on the integer face feature data, whether to unlock a terminal device.

In addition, the RAM 1003 may further store various programs and data required for operations of the apparatuses. The CPU 1001 or GPU 1013, the ROM 1002, and the RAM 1003 are connected to each other by means of the second communication bus 1004. In the presence of the RAM 1003, the ROM 1002 is an optional module. The RAM 1003 stores executable instructions, or writes the executable instructions to the ROM 1002 during running, where the executable instructions enable the second processor to perform corresponding operations of the foregoing communication method. An input/output (I/O) interface 1005 is also connected to the second communication bus 1004. The communication component 1012 may be an integrated component, or may include multiple sub-modules (e.g., multiple IB network cards), and is linked with the communication bus.

The following parts are connected to the I/O interface 1005: an input section 1006 including a keyboard, a mouse and the like; an output section 1007 including a Cathode-Ray Tube (CRT), a Liquid Crystal Display (LCD), a loudspeaker and the like; the storage section 1008 including hardware and the like; and the communication interface 1009 of a network interface card such as a LAN card and a modem. A drive 1010 is also connected to the I/O interface 1005 according to needs. A removable medium 1011 such as a disk, an optical disk, a photo-magnetic disk and a semiconductor memory is installed on the drive 1010 according to needs, to cause a computer program read from the removable medium 1011 to be installed into the storage section 1008 according to needs.

It should be noted that the architecture illustrated in FIG. 10 is merely an optional implementation mode. During practice, the number and types of the parts in FIG. 10 may be selected, decreased, increased, or replaced according to actual requirements. Different functional parts may be separated or integrated or the like. For example, the GPU and the CPU may be separated, or the GPU may be integrated on the CPU, and the communication element may be separated from or integrated on the CPU or the GPU or the like. These alternative implementations all fall within the scope of protection of the present disclosure.

Particularly, the process described above with reference to the flowchart according to the embodiments of the present disclosure is implemented as a computer software program. For example, the embodiments of the present disclosure provide a computer program product, which includes a computer program tangibly included in a machine-readable medium. The computer program includes a program code for executing a method shown in the flowchart. The program code may include corresponding instructions for correspondingly executing operations of the methods provided by the embodiments of the present disclosure, such as obtaining a face image, processing the face image to obtain integer face feature data, and determining, based on the integer face feature data, whether to unlock a terminal device. In the embodiments, the computer program may be downloaded from a network by means of the communication element and installed, and/or be installed from the removable medium 1011. When the computer program is executed by the second processor, the functions defined in the method according to the embodiments of the present disclosure are executed.

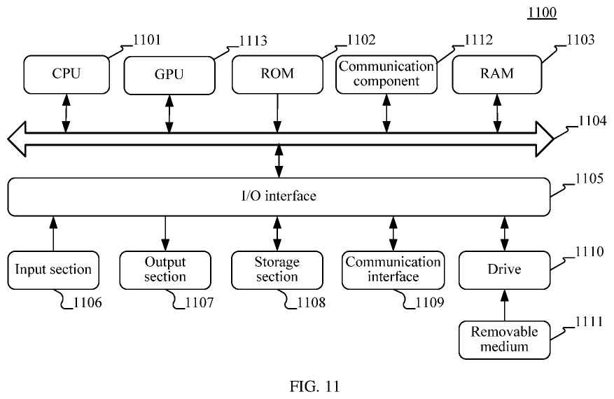

The embodiments of the present disclosure further provide an electronic device, such as a mobile terminal, a Personal Computer (PC), a tablet computer, and a server. Referring to FIG. 11 below, a schematic structural diagram of an electronic device 1100 adapted to implement a terminal device or a server according to the embodiments of the present disclosure is shown. As shown in FIG. 11, the electronic device 1100 includes one or more third processors, a third communication element, and the like. The one or more third processors are, for example, one or more Central Processing Units (CPUs) 1101 and/or one or more Graphic Processing Units (GPUs) 1113, and the third processors may execute various appropriate actions and processing according to executable instructions stored in a Read-Only Memory (ROM) 1102 or executable instructions loaded from a storage section 1108 to a Random Access Memory (RAM) 1103. In the embodiments, the third ROM 1102 and the RAM 1103 are collectively referred to as a third memory. The third communication element includes a communication component 1112 and/or a communication interface 1109. The communication component 1112 may include, but not limited to, a network card and the network card may include, but not limited to, an InfiniBand (IB) network card. The communication interface 1109 includes a communication interface of a network interface card such as a LAN card and a modem, and the communication interface 1109 performs communication processing via a network such as the Internet.

The third processors communicate with the ROM 1102 and/or the RAM 1103 to execute executable instructions, are connected to the communication component 1112 by means of the third communication bus 1104, and communicate with other target devices by means of the communication component 1112, so as to complete operations corresponding to any payment method provided in the embodiments of the present disclosure, such as obtaining a face image, processing the face image to obtain integer face feature data, and determining, based on the integer face feature data, whether to allow payment, or send a payment request including the integer face feature data to a server.

In addition, the RAM 1103 may further store various programs and data required for operations of the apparatuses. The CPU 1101 or GPU 1113, the ROM 1102, and the RAM 1103 are connected to each other by means of the third communication bus 1104. In the presence of the RAM 1103, the ROM 1102 is an optional module. The RAM 1103 stores executable instructions, or writes the executable instructions to the ROM 1102 during running, where the executable instructions enable the third processor to perform corresponding operations of the foregoing communication method. An input/output (I/O) interface 1105 is also connected to the third communication bus 1104. The communication component 1112 may be an integrated component, or may include multiple sub-modules (e.g., multiple IB network cards), and is linked with the communication bus.

The following parts are connected to the I/O interface 1105: an input section 1106 including a keyboard, a mouse and the like; an output section 1107 including a Cathode-Ray Tube (CRT), a Liquid Crystal Display (LCD), a loudspeaker and the like; the storage section 1108 including hardware and the like; and the communication interface 1109 of a network interface card such as a LAN card and a modem. A drive 1110 is also connected to the I/O interface 1105 according to needs. A removable medium 1111 such as a disk, an optical disk, a photo-magnetic disk and a semiconductor memory is installed on the drive 1110 according to needs, to cause a computer program read from the removable medium 1111 to be installed into the storage section 1108 according to needs.

It should be noted that the architecture illustrated in FIG. 11 is merely an optional implementation mode. During practice, the number and types of the parts in FIG. 11 may be selected, decreased, increased, or replaced according to actual requirements. Different functional parts may be separated or integrated or the like. For example, the GPU and the CPU may be separated, or the GPU may be integrated on the CPU, and the communication element may be separated from or integrated on the CPU or the GPU or the like. These alternative implementations all fall within the scope of protection of the present disclosure.

Particularly, the process described above with reference to the flowchart according to the embodiments of the present disclosure is implemented as a computer software program. For example, the embodiments of the present disclosure provide a computer program product, which includes a computer program tangibly included in a machine-readable medium. The computer program includes a program code for executing a method shown in the flowchart. The program code may include corresponding instructions for correspondingly executing operations of the methods provided by the embodiments of the present disclosure, such as obtaining a face image, processing the face image to obtain integer face feature data, and determining, based on the integer face feature data, whether to allow payment, or send a payment request including the integer face feature data to a server. In the embodiments, the computer program may be downloaded from a network by means of the communication element and installed, and/or be installed from the removable medium 1111. When the computer program is executed by the first processor, the functions defined in the method according to the embodiments of the present disclosure are executed.

It should be noted that according to needs for implementation, the parts/operations described in the present disclosure are separated into more parts/operations, and two or more parts/operations or some operations of the parts/operations are also combined into new parts/operations to achieve the purpose of the embodiments of the present disclosure.

The methods, apparatuses, and devices in the present disclosure are implemented in many manners. For example, the methods, apparatuses, and devices in the embodiments of the present disclosure are implemented with software, hardware, firmware, or any combination of software, hardware, and firmware. Unless otherwise specially stated, the foregoing sequences of operations of the methods are merely for description, and are not intended to limit the operations of the methods of the embodiments of the present disclosure. In addition, in some embodiments, the present disclosure may be implemented as programs recorded in a recording medium. The programs include machine-readable instructions for implementing the methods according to the embodiments of the present disclosure. Therefore, the present disclosure further covers the recording medium storing the programs for performing the methods according to the embodiments of the present disclosure.

The descriptions of the embodiments of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to make a person of ordinary skill in the art understand the present disclosure, so as to design various embodiments with various modifications applicable to particular use.

1. An identity authentication method, comprising:
obtaining first feature data of a first user image;
performing quantization processing on the first feature data to obtain second feature data; and
obtaining an identity authentication result based on the second feature data.

2. The method according to claim 1, further comprising: before the performing quantization processing on the first feature data, performing dimensionality increasing transform processing on the first feature data by using a transform parameter to obtain transformed data,
wherein the performing quantization processing on the first feature data to obtain second feature data comprises: performing quantization processing on the transformed data to obtain the second feature data.

3. The method according to claim 2, wherein the performing dimensionality increasing transform processing on the first feature data by using a transform parameter to obtain transformed data comprises:
determining a product of the first feature data and the transform parameter as the transformed data.

4. The method according to claim 2, further comprising: before the performing dimensionality increasing transform processing on the first feature data by using a transform parameter, initializing the transform parameter; and
performing iterative update on the initialized transform parameter based on multiple pieces of sample feature data, until an iteration termination condition is met.

5. The method according to claim 4, wherein the initializing the transform parameter comprises:
initializing the transform parameter by means of a Gaussian random function.

6. The method according to claim 4, wherein the performing iterative update on the initialized transform parameter based on the multiple pieces of sample feature data comprises:
performing dimensionality increasing transform processing on a first sample feature matrix of the multiple pieces of sample feature data based on current transform parameter to obtain a first transformed sample feature matrix;
performing quantization processing on the first transformed sample feature matrix to obtain a second sample feature matrix;
obtaining a first orthogonal matrix and a second orthogonal matrix based on the first sample feature matrix and the second sample feature matrix; and updating the current transform parameter based on the first orthogonal matrix and the second orthogonal matrix.

7. The method according to claim 6, wherein the updating the current transform parameter based on the first orthogonal matrix and the second orthogonal matrix comprises:
performing intercepting operation on the first orthogonal matrix to obtain an intercepted first orthogonal matrix; and
multiplying the second orthogonal matrix and the intercepted first orthogonal matrix to obtain an updated current transform parameter.

8. The method according to claim 2, wherein the transform parameter comprises a transform matrix, a number of columns of the transform matrix being an integer multiple of a number of rows of the transform matrix.

9. The method according to claim 1, wherein the obtaining an identity authentication result based on the second feature data comprises:
obtaining the identity authentication result of the first user image based on a matching result of the second feature data and preset feature data.

10. The method according to claim 9, further comprising: before the obtaining the identity authentication result of the first user image based on a matching result of the second feature data and preset feature data,
obtaining the preset feature data from a memory, the preset feature data being a binary numerical sequence.

11. The method according to claim 1, wherein the obtaining an identity authentication result based on the second feature data comprises:
obtaining third feature data of a second user image; and
obtaining an identity authentication result of the second user image based on a matching result of the third feature data and the second feature data.

12. The method according to claim 1, further comprising:
storing the second feature data into a template database.

13. The method according to claim 1, wherein the obtaining first feature data of a first user image comprises:
obtaining the first user image; and
performing feature extraction on the first user image to obtain the first feature data of the first user image.

14. The method according to claim 1, wherein the second feature data comprises a binary numerical sequence.

15. An unlocking method, comprising:
obtaining a face image;
processing the face image to obtain integer face feature data; and
determining, based on the integer face feature data, whether to unlock a terminal device.

16. The method according to claim 15, wherein the processing the face image to obtain integer face feature data comprises:
performing feature extraction on the face image to obtain floating-point face feature data; and
performing quantization processing on the floating-point face feature data to obtain the integer face feature data.

17. The method according to claim 15, wherein the integer face feature data comprises a binary numerical sequence.

18. The method according to claim 15, wherein the determining, based on the integer face feature data, whether to unlock of a terminal device comprises:
determining, based on whether the integer face feature data matches preset face feature data, whether to unlock of the terminal device, wherein the preset face feature data is integer data.

19. A non-transitory computer readable storage medium having stored thereon computer program instructions that, when executed by a computer, cause the computer to perform:
obtaining first feature data of a first user image;
performing quantization processing on the first feature data to obtain second feature data; and
obtaining an identity authentication result based on the second feature data.

20. An electronic device, comprising: a first processor and a first memory, wherein the first memory is configured to store at least one executable instruction which, when executed by the first processor, causes the first processor to execute the operations of the identify authentication method of claim 1.
